(19) United States
(12) Patent Application Publication
(10) Pub. No.: US 2024/0144360 A1
(43) Pub. Date: May 2, 2024

(54) COMPUTER-IMPLEMENTED METHODS, APPARATUSES AND COMPUTER PROGRAM PRODUCTS FOR USE IN MANAGING THE LEVERAGE EXPOSURE OF A PLURALITY OF FINANCIAL INSTITUTIONS

(71) Applicant: DNY Match Limited, London (GB)

(72) Inventor: Robert Clark, London (GB)

(21) Appl. No.: 18/278,698

(22) PCT Filed: Feb. 25, 2022
(86) PCT No.: PCT/GB2022/050525

§ 371 Date: Aug. 24, 2023

(30) Foreign Application Priority Data
Feb. 26, 2021 (GB) 2102836.0

(51) Int. Cl. G06Q 40/02

(52) U.S. Cl. CPC G06Q 40/02

(57) ABSTRACT

The application discloses a system of networked computing apparatus, software and methods of operation comprising a settlement exposure analysis node, a plurality of financial institution nodes, one for each participating financial institutions, and a regulated arranger node. The nodes are configured to, in use, transfer data representative of initial net settlement exposures of the parfinancial institutions from the financial institution nodes to the settlement exposure analysis node, transfer data representative of the values of a repo trade matrix x_{i,j} generated by the settlement exposure analysis node to the financial institution nodes, and, based on data representing approval of the repo trade matrix x_{i,j} by all of the participating financial institution nodes, settle trade orders between pairs of the financial institutions i,j based on the trade values in the repo trade matrix x_{i,j} for those counterparties.

This present application relates to apparatuses and methods for managing settlement or leverage exposures by participants in the repo market.

### BACKGROUND

A repurchase agreement, also known as a repo, RP, or sale and repurchase agreement, is a form of short-term borrowing, mainly in government securities. The dealer sells the underlying security to investors and, by agreement between the two parties, buys them back shortly afterwards, usually the following day, at a slightly higher price.

The repo market is an important source of funds for large financial institutions in the non-depository banking sector, which has grown to rival the traditional depository banking sector in size. Large institutional investors such as money market mutual funds lend money to financial institutions such as investment banks, either in exchange for (or secured by) collateral, such as Treasury bonds and mortgage-backed securities held by the borrower financial institutions. Repurchase agreements are generally considered safe investments because the security in question functions as collateral.

Repurchase agreements can take place between a variety of parties. Individuals normally use these agreements to finance the purchase of debt securities or other investments. An estimated volume of $3-5 tn a day are traded on the repo market to provide liquidity for investment bank operations through short term borrowing. Thus bilateral repo markets are essential components of a well-functioning financial system. But their volumes and liquidity are constrained by the leverage ratio, which restricts banks' balance sheet sizes and their repo volumes.

A bank's leverage exposure stems from the level of its unmatched trades, and following the financial crisis in 2008, banks are subject to stringent Leverage Exposure (LE) regulations in that they must maintain sufficient regulatory capital to cover leverage exposure as required by Basel principles. Given that the total leverage exposure in the repo market at any one time is on the order of $4 tn, the cost of capital for maintaining the regulatory capital to protect against leverage exposure is on the order of $10 bn a year.

It is in the above context that the present disclosure has been devised.

### BRIEF SUMMARY OF THE DISCLOSURE

Each bank needs to manage its leverage exposure through the repo market to manage and understand its regulatory capital requirements, and to ensure it is sufficiently capitalised while avoiding costly overcapitalisation. Banks can manage some of their leverage exposure on “clearable” trades by novating transactions to a Central Clearing Counterparty (CCP). However, less than around 50% of repo market trades are clearable through a CCP, and further, banks need to put a CCP in funds through collateral deposits, the return on which is typically poor. The remainder of the repo market is through bilateral agreements between banks. However, there is no multilateral mechanism for managing uncleared trades and residual exposure to CCPs.

The apparatus and method of the present disclosure provide a multilateral facility for the management of bilateral repo exposures, providing its users with a simple, scalable, value-for-money approach to leverage exposure management. The apparatus and method mitigates regulatory exposures from repo transactions by designing a set of risk-reducing transactions to offset them. In doing so, it creates additional leverage capacity which enhances repo market liquidity while being entirely consistent with Basel principles.

In accordance with various aspects of the disclosure, the apparatus and method captures a matrix of net settlement exposures between participating counterparties in the repo market. The apparatus and method stipulates a set of axioms/constraints which allow each market participant to participate easily in matching the trades and lowering their leverage exposure. The apparatus and method uses an optimisation algorithm to create a series of new proposed transactions which satisfy every participant's constraints.

Upon execution of the new series of transactions each participant will have reduced their settlement exposure. All the trades proposed by the apparatus and method need to be executed to achieve this goal.

Thus the invention resolves the problem of leverage exposure and is also capable of extension to replace CCPs with a more efficient process whilst also reducing systemic risk in the financial system. Extension to replacing CCPs would also be available to a wider group of counterparties beyond just the members of the CCPs.

In accordance with the apparatus and method of the present disclosure, repo market participants are allowed greater freedom to trade with any other participant who is axed to do the transaction in the knowledge that the overall LE will be managed at the portfolio level. Thus a top down multi-dimensional approach to reducing leverage exposure is provided.

Thus viewed from one aspect, the present disclosure provides computing apparatus for providing a settlement exposure analysis node for use in managing the leverage exposure of a plurality of financial institutions, comprising: one or more processors; and memory comprising instructions which when executed by one or more of the processors, causes the processors to: receive, for each i of a plurality n of financial institutions i=1 . . . n, data representative of the initial net settlement exposure E_{i,j} of that financial institution i to others of the plurality of financial institutions as counterparties j=1, . . . n, the net settlement exposure E_{i,j} indicated as net positive or negative cashflow obligations between the financial institutions at a target settlement date corresponding to a date intended for a set of repurchase agreements to be determined and entered into; establish a settlement exposure matrix containing the initial net settlement positions E_{i,j} for the plurality of financial institutions, and determine: for each financial institution i of the plurality of financial institutions, a total initial net settlement exposure to the j=1 . . . n counterparties as:

$$∀ i {\sum }_{j = 1}^{n} {E}_{i , j}$$

and, for each financial institution i of the plurality of financial institutions, a total initial gross settlement exposure to the j=1 . . . n counterparties based on an absolute amount of the settlement exposure as:

$$∀ i {\sum }_{j = 1}^{n} \vert {E}_{i , j} \vert$$

establish a repo trade matrix x_{i,j} for holding values of symmetrical trades for a set of bilateral repurchase agreements to be determined and entered into between financial institutions i,j=1 . . . n; determine, using an optimisation function, values of the repo trade matrix x_{i,j} that minimise a total gross new settlement exposure for all of the financial institutions i,j=1 . . . n, the total gross new exposure being calculated by:

$${\sum }_{i = 1}^{n} {\sum }_{j = 1}^{n} \vert {x}_{i , j} + {E}_{i , j} \vert$$

wherein the optimisation is subject to the constraint that for each financial institution i of the plurality of financial institutions, a total new gross settlement exposure to the j=1 . . . n counterparties after the trades is less than the total initial gross settlement exposure to the j=1 . . . n counterparties, such that:

∀iΣⱼ₌₁ⁿ|x_{i,j}+E_{i,j}|≤Σⱼ₌₁ⁿ|E_{i,j}| and;

cause to be transmitted to one or more financial institution nodes each accessible by one of the financial institutions, data representative of the values of the repo trade matrix x_{i,j}, the values of the repo trade matrix x_{i,j} being usable, on approval by the financial institutions, to settle trade orders between the financial institutions i,j=1 . . . n to reduce a leverage exposure for each of the financial institutions i,j=1 . . . n.

Viewed from another aspect, the present disclosure provides computing apparatus for providing a financial institution node, accessible by a financial institution i, for use in managing the leverage exposure of a plurality of financial institutions, comprising: one or more processors; and memory comprising instructions which when executed by one or more of the processors, causes the processors to: cause to be transmitted to a settlement exposure analysis node data representative of initial net settlement exposures E_{i,j} of that financial institution i to others of the plurality of financial institutions as counterparties j=1, . . . n, the net settlement exposure E_{i,j} indicated as net positive or negative cashflow obligations between the financial institutions at a target settlement date corresponding to a date intended for a set of repurchase agreements to be determined and entered into; receive data representative of the values of a repo trade matrix x_{i,j} determined by the settlement exposure analysis node, the repo trade matrix x_{i,j} holding values of symmetrical trades for a set of bilateral repurchase agreements to be entered into between the financial institution i and the plurality of other financial institutions as counterparties j=1, . . . n to reduce a leverage exposure for each of the financial institutions i,j=1 . . . n; and causing to be transmitted data representing approval of the repo trade matrix x_{i,j} to settle trade orders between the financial institution i and each of the j=1 . . . n counterparties.

Viewed from another aspect, the present disclosure provides computing apparatus for providing a regulated arranger node for use in managing the leverage exposure of a plurality of financial institutions, comprising: one or more processors; and memory comprising instructions which when executed by one or more of the processors, causes the processors to: receive from a plurality of financial institution nodes, data representative of initial net settlement exposures E_{i,j} of each financial institution i=1, . . . n to others of the plurality of financial institutions as counterparties j=1, . . . n; validate the data representative of initial net settlement exposures E_{i,j}; send to the settlement exposure analysis node, the data representative of initial net settlement exposures E_{i,j}; receive from the settlement exposure analysis node, data representative of the values of the repo trade matrix x_{i,j} determined by the settlement exposure analysis node; validate the data representative of the values of the repo trade matrix x_{i,j}; send to the plurality of financial institution nodes, the data representative of the values of the repo trade matrix x_{i,j}; receive or generate based on predetermined acceptance conditions determined by one or more of the financial institutions, data representing approval of the repo trade matrix x_{i,j} by all of the financial institutions; and cause trade orders to be executed between pairs of the financial institutions i,j based on the trade values in the repo trade matrix x_{i,j} for those counterparties.

Viewed from another aspect, the present disclosure provides a system of networked computing apparatus comprising: computing apparatus for providing a settlement exposure analysis node as described herein; a plurality of computing apparatus each for providing a financial institution node for one of the participating financial institutions as described herein; and computing apparatus for providing a regulated arranger node as described herein; wherein the settlement exposure analysis node, regulated arranger node and at least one financial institution node are configured to, in use, transfer data representative of initial net settlement exposures of the participating financial institutions from the financial institution nodes to the settlement exposure analysis node, transfer data representative of the values of a repo trade matrix x_{i,j} generated by the settlement exposure analysis node to the financial institution nodes, and, based on data representing approval of the repo trade matrix x_{i,j} by all of the participating financial institution nodes, settle trade orders between pairs of the financial institutions i,j based on the trade values in the repo trade matrix x_{i,j} for those counterparties. In embodiments, one or more of the settlement exposure analysis node, regulated arranger node and at least one financial institution node may be configured to securely store the transferred data in a distributed ledger maintained by at least each of the nodes based on a consensus mechanism. In embodiments, the distributed ledger maintained by the nodes may store instructions implementing smart contracts which when executed, cause a processor of one of the nodes to, based on based on data representing approval of the repo trade matrix x_{i,j} by all of the participating financial institution nodes, settle trade orders between pairs of the financial institutions i,j based on the trade values in the repo trade matrix x_{i,j} for those counterparties.

In this way, by the collation and validation of the data in a transparent way using a distributed ledger, by using an optimisation function to minimise an objective function, and by using smart contracts to automatically settle the trades, the system of networked computing apparatus can securely and reliably automatically construct and execute a set of bilateral repo market trades to reduce the leverage exposure of the participating financial institutions.

### BRIEF DESCRIPTION OF THE DRAWINGS

Examples of the present disclosure are further described hereinafter with reference to the accompanying drawings, in which:

FIG. 1 shows an example system for management of settlement exposures by participants in the repo market, implemented by an apparatus and method in accordance with the present disclosure;

FIG. 2 shows an example submission (of fabricated data) received from an example bank;

FIG. 3 shows a matrix of the initial leverage exposure between the different participating banks;

FIG. 4 shows a matrix of exposure limits on the sizes of the new trades;

FIG. 5 shows the configuration panel for the operational parameters for the solver algorithm;

FIG. 6 shows the results of the solver algorithm for the participating banks;

FIG. 7 shows the new exposure matrix between the participating banks after all the trades are executed;

FIG. 8 shows a detailed trade blotter of the offsetting trades generated for the selected participating bank;

FIG. 9 shows a detailed trade blotter of the offsetting trades generated for the CCP, where the CCP is included in the solver;

FIG. 10 shows the matrix of offsetting trades generated by the solver for all participants;

FIGS. 11 and 12 illustrate in more detail the implementation of the apparatus and method using a distributed ledger technology with Smart Contracts;

FIG. 13 shows a table illustrating a possible net settlement position in millions of euros on a single value-date for a fictional group of five banks;

FIG. 14 shows a table illustrating a set of risk-mitigating repo transactions generated by the solver;

FIG. 15 shows a table illustrating the result of these risk-mitigating transactions on the leverage exposure of the banks;

FIG. 16 shows a block diagram of a computing apparatus suitable for use as a financial institution node, a regulated arranger node, or a settlement exposure analysis node in accordance examples of the present disclosure;

FIG. 17 shows a flowchart of a computer-implemented method of a settlement exposure analysis node in accordance with examples of the present disclosure;

FIG. 18 shows a flowchart of a computer-implemented method of a financial institution node in accordance with examples of the present disclosure; and

FIG. 19 shows a flowchart of a computer-implemented method of a regulated arranger node in accordance with examples of the present disclosure.

### DETAILED DESCRIPTION

The present disclosure describes an apparatus and method for efficient management of settlement exposures by participants in the repo market.

The method may be codified in software held in memory storage accessible by networked computing apparatus, and when executed by one or more processors of the networked computing apparatus, cause the apparatus to carry out one or more steps of the following method.

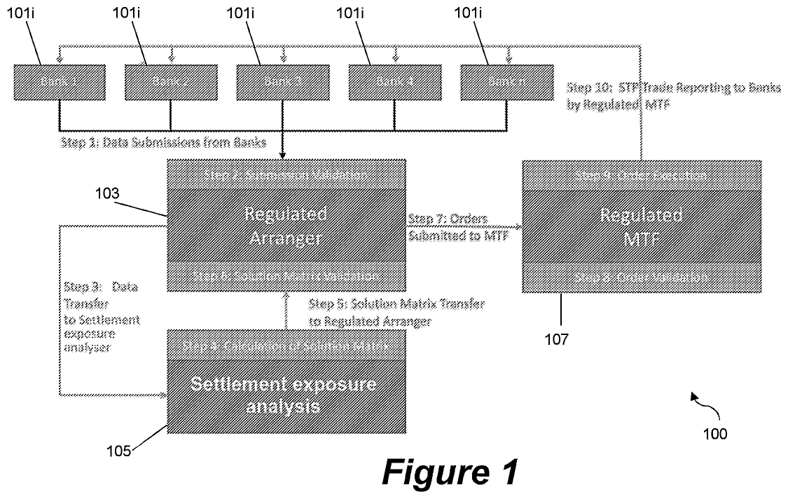

Referring to FIG. 1, which shows an example system 100 for management of settlement exposures by participants in the repo market comprising the apparatus of the present disclosure, the apparatus includes networked computing apparatus for settlement exposure analysis. The apparatus may further include networked computing apparatus for acting as a regulated arranger of the trades between the participating banks. The system 100 may use distributed ledger technology (DLT) to enhance security and confidence of participants. Further, the use of smart contracts may facilitate the automated digital requirements of the system 100. In this respect, the networked computing apparatus for Settlement Exposure Analysis 105 and the networked computing apparatus for acting as a Regulated Arranger 103 may represent DLT nodes. Steps of the method from receiving submissions from the banks 101i to the returning of the settlement solution matrix of trades to each bank may occur within a DLT perimeter, in which the trades may be governed by a smart contract, which if approved can result in straight through processing (STP) trade orders being submitted to an Multilateral Trading Facility (MTF) 107 for automated order execution.

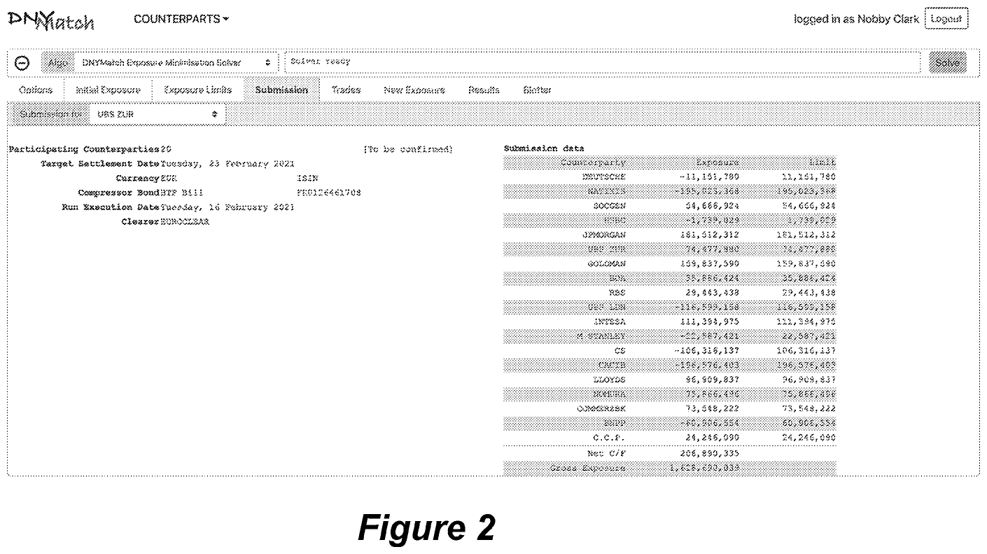

An example method and operational dataflow of the present disclosure will now be described in relation to FIGS. 1 to 10. The apparatus and method may operate close to the end of the trading day, on a daily basis with an operational timeline illustrated in FIG. 1. A user interface of the apparatus illustrating these steps is shown in FIGS. 2 to 10.

As can be seen in step 1, data submissions are received from participating banks 101i (where i=1 . . . n). In embodiments, the data submissions may take the form of net settlement positions for the relevant settlement date and currency are submitted to the regulated arranger processing node 103. An example submission (of fabricated exposure data) received from an example bank (in this case UBS ZUR) is shown in FIG. 2. This tab shows the format that Banks will submit their exposures. The table of data presents the column of Counterparties (again, randomly selected from known players in Repo market in this example), a column of Exposures (again, randomly generated), and another column identifying the limit on sizes of New Trades (Equal to current exposures in this example). The submissions include further data such as the date of the run, the target exposure date, the security to be used in all transactions and the settlement venue (Euroclear in this example). The submissions may be automatic and by secure API to DLT nodes for each bank inside the DLT perimeter. The data required for the system 100 is thus very simple and the fact that it is already produced by banks increases the likely adoption.

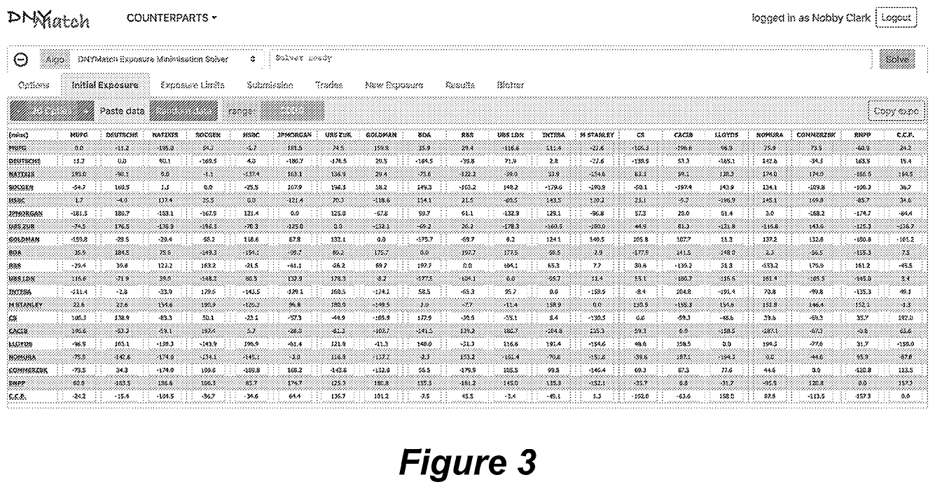

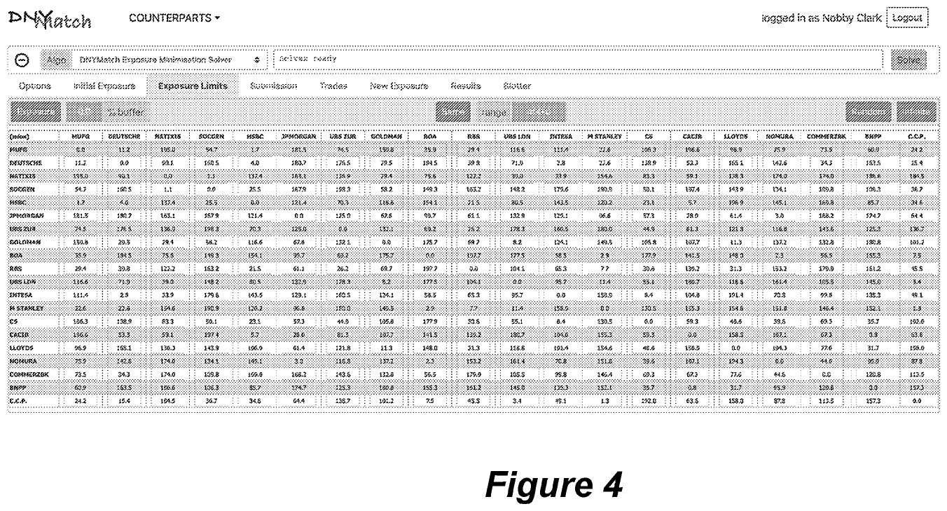

Once settlements are received from all participating Banks 101i 1 . . . n at the Regulated Arranger 103, in step 2 the submissions are validated at the Regulated Arranger node 103 by checking and validating the data. In step 3, the received data may then be transferred to Settlement Exposure Analysis 105 node. As shown in FIG. 3, this can be shown in a matrix illustrating the initial settlement exposure between the different participating banks. The matrix is of the exposures every participant has with each other participant on the target settlement date. The matrix has symmetry across the diagonal as Participant A's exposure to Participant B is the opposite of Participant B's exposure to Participant A. In the example shown, the data is illustrative and generated randomly within a specified range. The Bank names are also taken at random from a list of known players in the Repo market. FIG. 4 shows a matrix of exposure limits on the sizes of the new trades, which in this case equals the size of each exposure in the Initial Exposure tab.

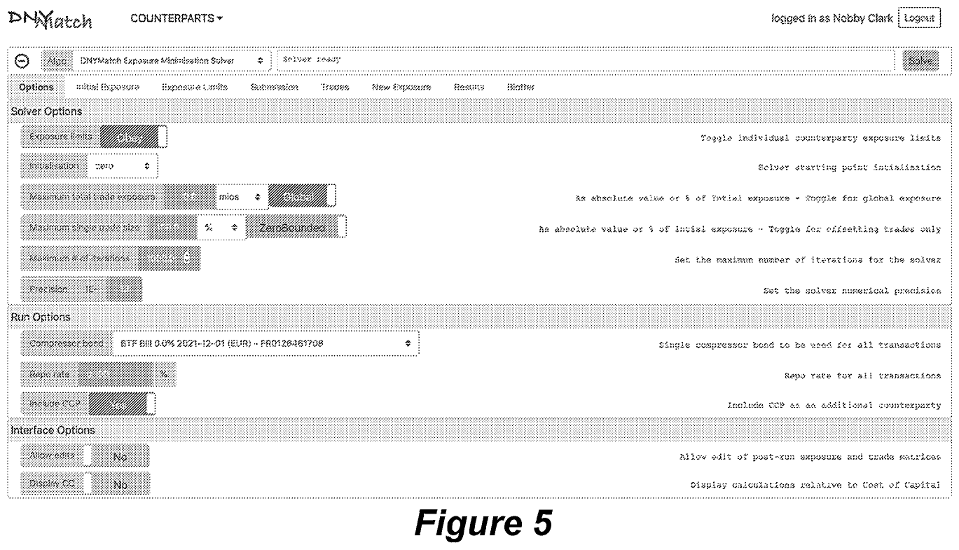

On receipt of this data, in step 4, the Settlement Exposure Analysis node 105 is then configured to solve the initial exposure position to reduce the overall exposure for the participating banks using an appropriately configured optimisation or ‘solver’ algorithm minimises the Leverage Exposure of the whole system whilst ensuring each trade contributes to exposure reduction for each participant. This treats counterparties fairly. The operational parameters for the solver algorithm may be configured at the Settlement Exposure Analysis node 105, as shown in FIG. 5. As shown the solver can be configured by allowing the selection of a particular algorithm, the setting of what Limits (constraints) can be applied to the optimisation, whether or not the limits should be obeyed, whether to include exposures to the Central Clearing Counterparty (CCP), the details of the bond used for all proposed transactions, whether to include cost of capital or any other fees. There is no price negotiation required as no one is exposed to the price at which all the trades are executed, and all trades will use the same price and the net of all trades is zero for all participants. This increases the likelihood of adoption.

Once the solver is configured, it is run to generate a set of trades between the participating banks that optimises the resulting matrix of new exposures to reduce the overall exposure and the exposure for each participating bank. The solver effectively provides the answer that says “If you do these trades you achieve this result” in reducing LE for the participants.

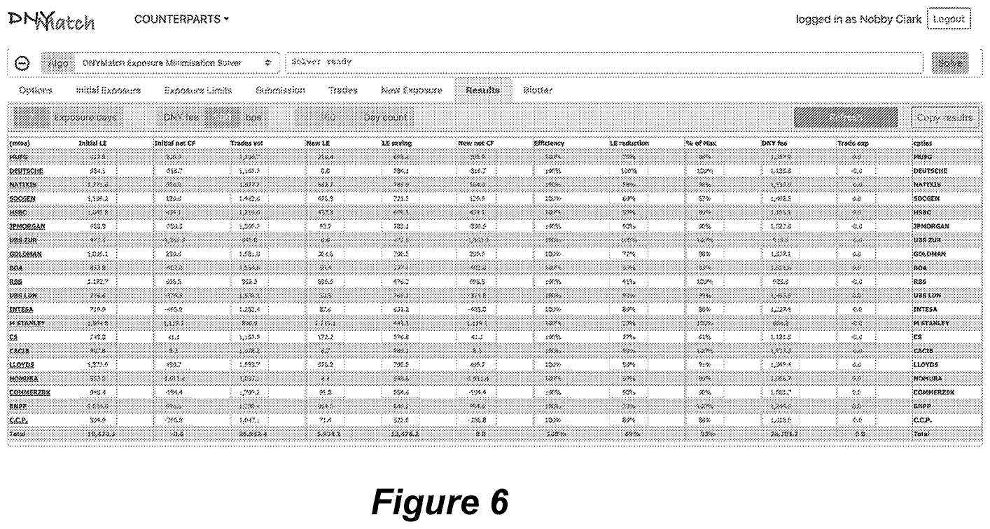

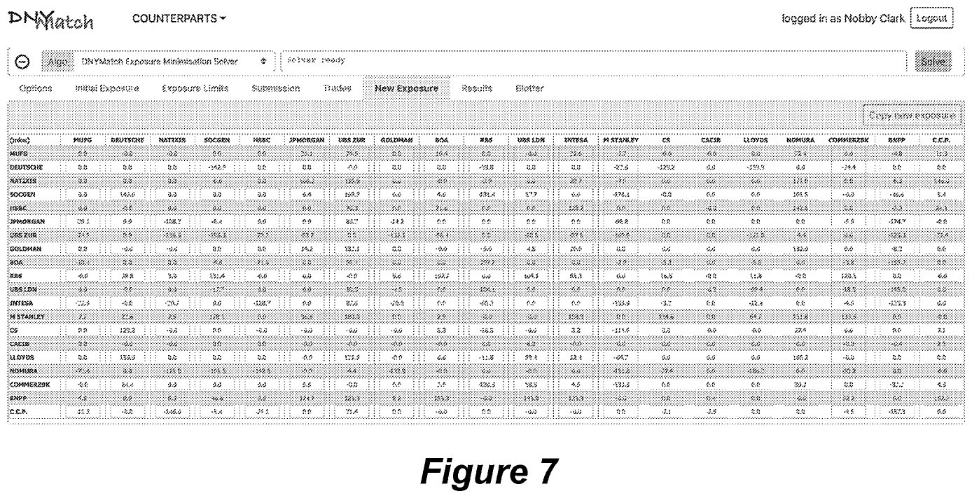

The results of the solver are shown in FIG. 6 for every participant. The columns show for each bank the aggregate Leverage Exposure(LE) before the run and then various details after the run including the new LE, the LE Saving (absolute and percentage), New Trade Exposure, any fees and the Efficiency Ratio. At 100%, the Efficiency Ratio confirms that every trade contributes to an LE Saving for each participant ensuring each participant is treated fairly. Another good indicator of the success of the run is the % age of max which measures how close to the maximum possible saving each participant has achieved. In the example shown a 93% of max possible saving would be achieved by executing the trades generated by the solver algorithm in the run. In this respect, FIG. 7 shows what the new exposure matrix between the participating banks would be after all the trades are executed.

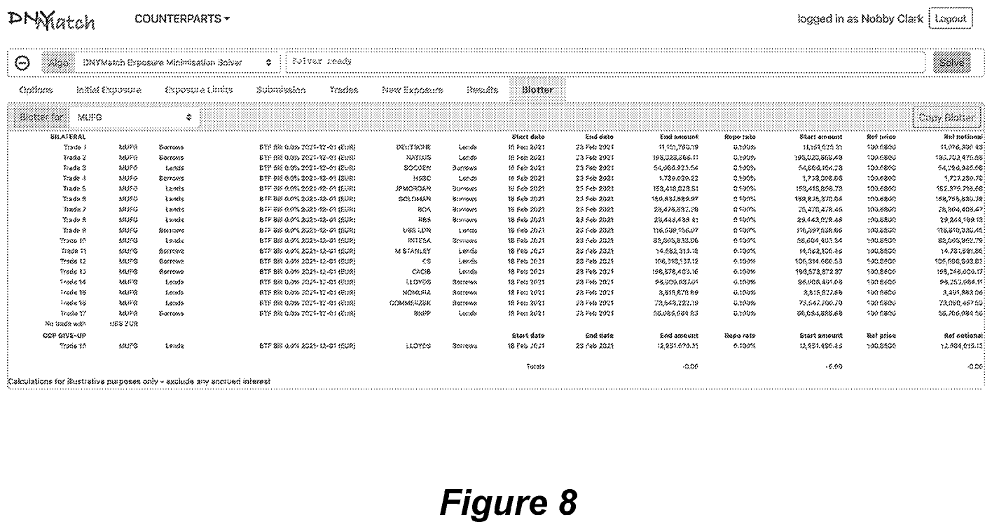

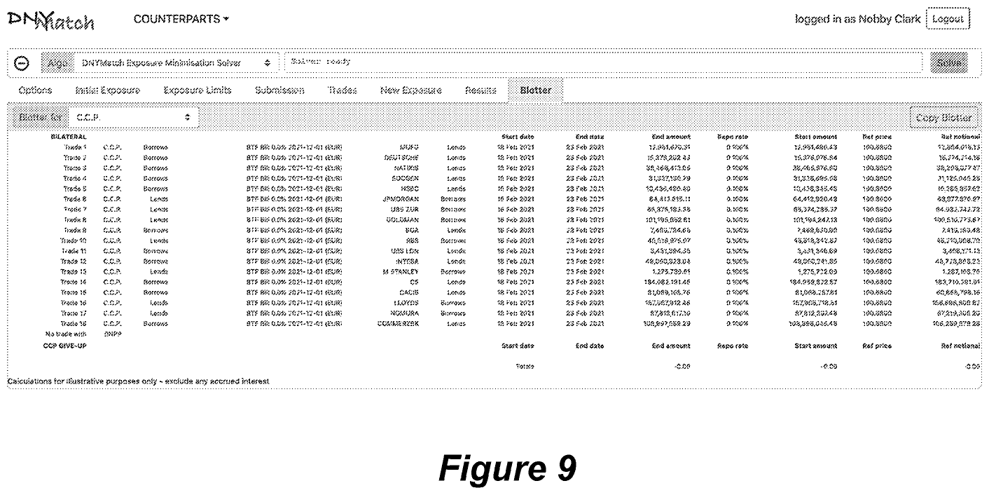

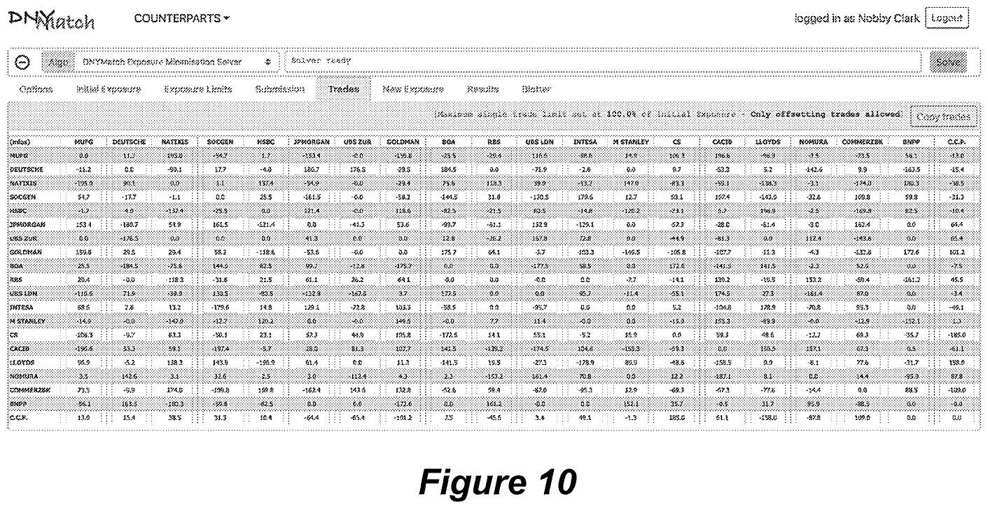

FIG. 8 shows a detailed trade blotter of the offsetting trades generated for the selected participating bank (in this case MUFG) by the solver. It is important to note that the sum of all trades adds up to zero, as it does for every participant. Similarly, where the CCP is included in the solver as a participant, FIG. 9 shows a detailed trade blotter of the offsetting trades generated for the CCP. Finally, FIG. 10 shows the matrix of offsetting trades generated by the solver for all participants.

As the sum of all proposed trades for each participant must add up to zero (cash legs and security legs), this ensures each participant has no change in their economic risk profile (only their exposure to the other participants will change). This means that pricing will be straight-forward (all trades will use the same price) and no price negotiation required as no one is exposed to the price at which all the trades are executed.

Referring again to FIG. 1, once the solution matrix is generated, in step 5 this is then transferred to the Regulated Arranger 103, which, on receipt of the solution matrix of recommended trades, is validated. At this stage, the recommended optimising trades for each bank 101i will be shared with the participants for approval. The recommended trades should be agreed by all the participants, or any one of them can halt the entire process. Smart contracts and DLT assist with the management and execution of these trades. Assuming the trades are approved for execution by all participating banks 101i, in Step 7 trade execution instructions are generated and passed to a multilateral trading facility 107 (henceforth MTF), such as TradeWeb for execution by straight through processing (STP) on an “all or nothing” basis. As a result, in the example shown, the LE of the participant bank MUFG is reduced from an initial value of 917.8 to a new LE value of 219.4, a saving of 698.4 or 76%. Further, the total LE is reduced from 19,470.3 to 5994.1, a saving of 13,476.2 or 69%. This reduces significantly the LE of the participating banks, commensurately reducing their regulatory capital requirement, and the attendant cost of their regulatory capital reserves is reduced significantly, leading to lower costs and higher volumes and liquidity being provided in the repo market.

Another illustrative example of the effects of the solver on participants is shown below.

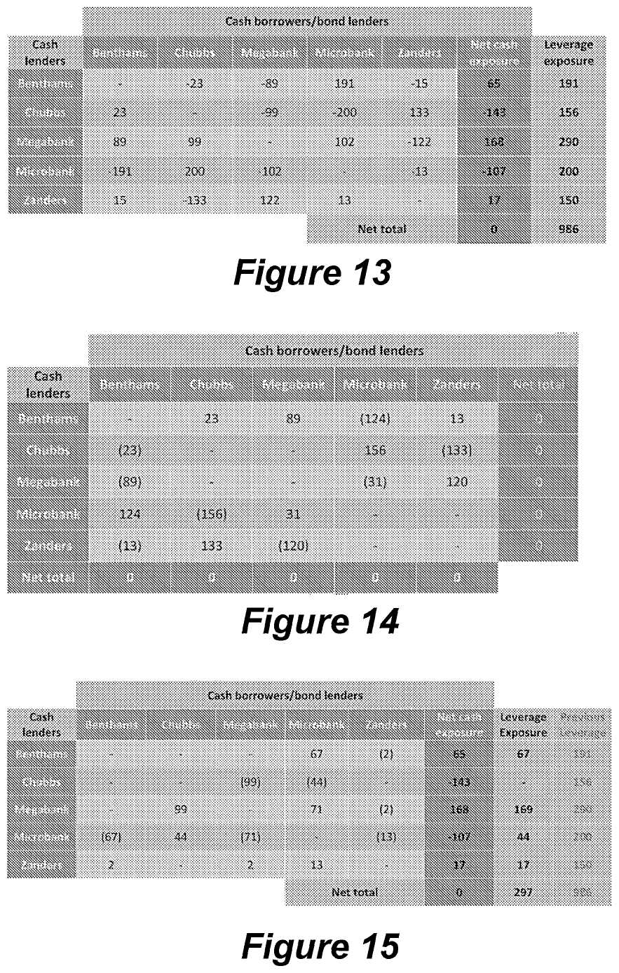

FIG. 13 shows a table illustrating a possible net settlement position in millions of euros on a single value-date for a fictional group of five banks. The matrix is symmetric because the settlement positions are bilateral. All transactions are assumed to settle via a single clearing system and therefore qualify for cash netting for the purpose of leverage exposure calculation.

In this example, the net cash position across the five banks is zero. However, the Repo transactions create €986 m of leverage exposure across the five institutions concerned: their individual bilateral positions are very much non-zero.

The apparatus and method of the present disclosure provide a unique algorithm that can generate a set of risk-mitigating repo transactions: all for the same value-date, all based on an identical short-dated euro-denominated government bond, and all netting to zero. These transactions have no impact on the market and no impact on any of the five institutions' net trading positions. These transactions are illustrated below in Table 2 shown in FIG. 14.

The result of these risk-mitigating transactions is illustrated in Table 3 shown in FIG. 15, which shows that, after executing the transactions, the five institutions' total leverage exposure drops dramatically, from €986 m to €297 m, a reduction of 70% overall. As the number of participants increases, the risk-mitigation algorithm becomes more efficient.

Thus broadly, the present disclosure provides a method which may comprise the following steps:
Each of the participants supplies their data
The data is checked and normalised for mathematical symmetry
The solver Algorithm is run to identify the proposed solution
The proposed solution is checked against each participant's constraints
Only if all participants constraints are satisfied is the proposed solution approved for execution
Approved trades are executed digitally using straight through processing (STP) without the need for manual intervention.

The execution requirements of proposed transactions can be specified. The front leg of all transactions will settle on the trade date. Using DLT smart contracts will ensure minimal (zero) settlement failures, improving efficiency and reducing costs. This turns the proposed trades into actual trades.

The frequency the apparatus and method's operational runs can be determined by client demand: any participant may request a run on any date and every other participant may choose to participate. Minimum and maximum trade sizes are specified by each participant, together with its transaction limits vis-a-vis other participants, in order to ensure that the transaction-set generated by the apparatus and method is mutually acceptable.

Separate exposure sets are required for each currency, date and settlement venue.

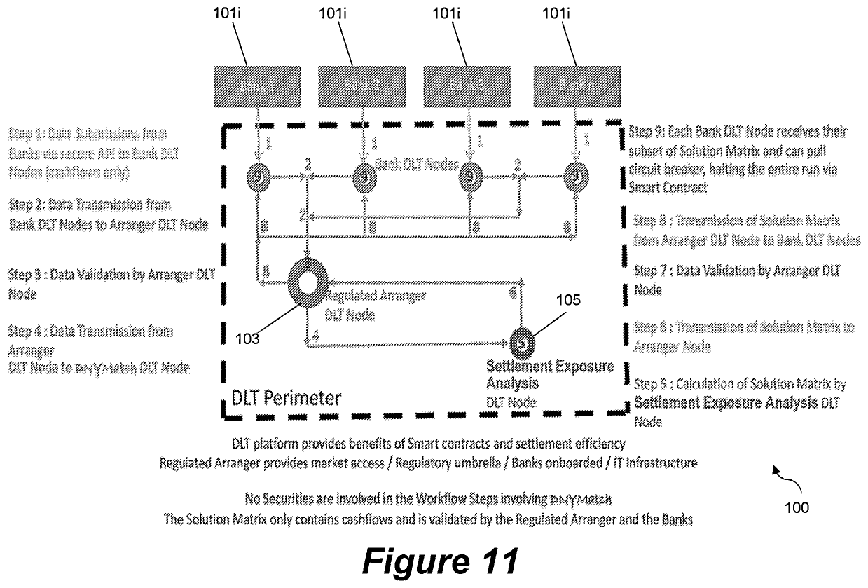

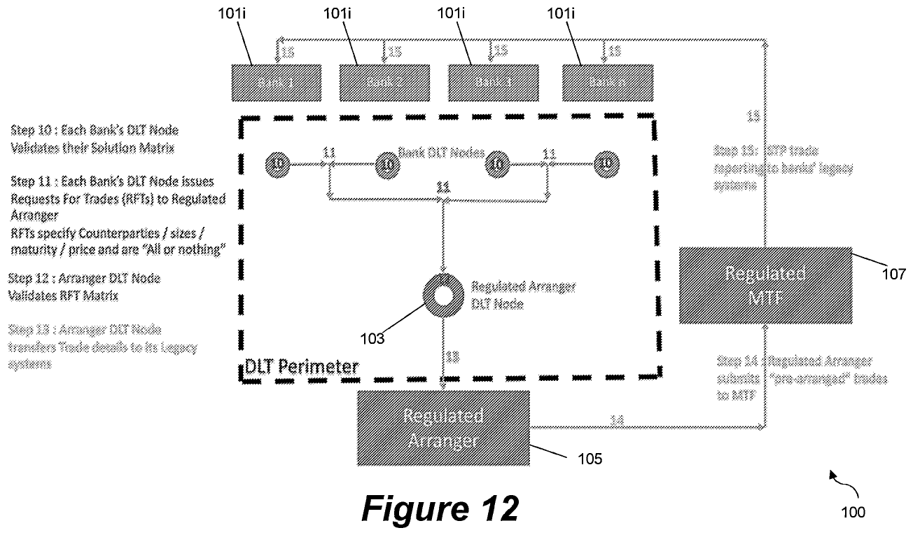

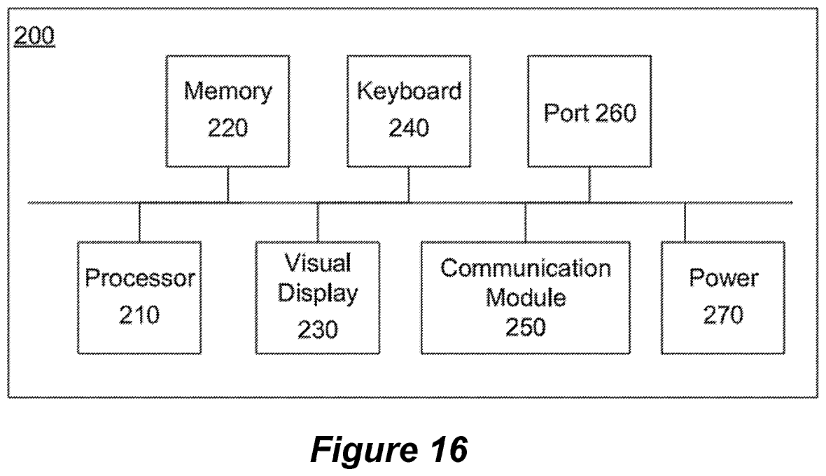

FIGS. 11 and 12 illustrate in more detail the implementation of the apparatus and method using a distributed ledger technology with Smart Contracts, using a system 100 of networked computing apparatus like in FIG. 1. Here, like numbers refer to like components of the system 100. The computing apparatus and software configured methods for implementing the system 100 in FIGS. 1, 11 and 12 will now be described in relation to FIGS. 16, 17, 18 and 19.

FIG. 16 is a block diagram of a computing apparatus 200. For example, computing apparatus 200 may comprise a computing device, a server, a mobile or portable computer or telephone and so on. Computing apparatus 200 may be distributed across multiple connected devices. Computing apparatus 200 may be suitable for use as any node of a system 100 of networked computing apparatus for use in managing the leverage exposure of a plurality of financial institutions as described herein, in particular in relation to FIGS. 1, 11 and 12. The computing apparatus 200 may be suitable for use as a financial institution node 101i, a regulated arranger node 103, or a settlement exposure analysis node 105. Other architectures to that shown in FIG. 16 may be used as will be appreciated by the skilled person.

Referring to FIG. 16, computing apparatus 200 includes one or more processors 210, one or more memories 220, a number of optional user interfaces such as visual display 230 and virtual or physical keyboard 240, a communications module 250, and optionally a port 260 and optionally a power source 270. Each of components 210, 220, 230, 240, 250, 260, and 270 are interconnected using various busses. Processor 210 can process instructions for execution within the computing apparatus 200, including instructions stored in memory 220, received via communications module 250, or via port 260.

Memory 220 is for storing data within computing apparatus 200. The one or more memories 220 may include a volatile memory unit or units. The one or more memories may include a non-volatile memory unit or units. The one or more memories 220 may also be another form of computer-readable medium, such as a magnetic or optical disk. One or more memories 220 may provide mass storage for the computing apparatus 200. Instructions for performing a method as described herein in relation to FIG. 1, 11, 12, 17, 18 or 19 may be stored within the one or more memories 220 as computer program products comprising one or more software modules. The one or more memories 220 may further store software modules for implementing a distributed ledger for storing the representative of initial net settlement exposures, data representative of the values of the repo trade matrix and data representing approval of the repo trade matrix by all of the financial institutions. The blocks of the blockchain implementing the distributed ledger maybe copied between the nodes based on a suitable consensus mechanism to maintain the latest version of the blockchain at each node, providing a tamper-proof record of the data transacted in implementing the methods. The software modules may also configure the distributed ledger to store executable instructions implementing smart contracts, such that one or more steps of the methods disclosed herein may be implemented automatically, improving the reliability and efficiency and security of the system 100.

A blockchain, sometimes known as a distributed ledger or a distributed consensus ledger, is a type of distributed database. A blockchain enables tamper-resistant and decentralised storage of data. A copy of the ledger/blockchain can be stored on each of multiple nodes of a blockchain network. In the present examples, one or more of the nodes of the network in the DLT perimeter, including financial institution nodes 101i, regulated arranger node 103, and settlement exposure analysis node 105, may store a copy of the ledger.

A blockchain comprises a plurality of block records, also known as blocks or data structure blocks. A block record of a blockchain typically comprises payload data (i.e. the data recorded in that block record for storage in the blockchain, such as the data representative of initial net settlement exposures, data representative of the values of the repo trade matrix, and data representing approval of the repo trade matrix by all of the financial institutions), a unique identifier of a preceding block record of the blockchain, and a proof-of-work (POW). When a block record is added to the blockchain, copies of the new block/blockchain are distributed to other nodes of the blockchain network, which can verify the work done to append the new block and accept the update to the blockchain or can disregard the new block if the associated work cannot be verified.

A block record typically comprises payload data in the form of data and/or computer-executable instructions. In this way, if the blockchain is used, for example, to record instructions such as transactions, then a complete history of transactions can be established on the ledger. Each transaction is a data structure that encodes the transfer of control of a digital asset from one party of a blockchain system to another. If the blockchain is used, for example, to record computer-executable instructions (referred to as a “smart contract”—a computerized protocol that executes the terms of a machine-readable contract or agreement) then function calls to the computer-executable instructions can be used to initiate a computer-executable process. A smart contract can process inputs in order to produce results, which can then cause actions to be performed based on those results.

Each block record typically contains a link to a preceding block record, for example, a hash value of the information in the preceding block record or a hash value of a header of the previous block record. The hash value is typically determined by using the information of the preceding block as part of the input to a hash function which outputs the hash value. Each block record links back to the preceding block record. In this way, once validated, a block record will be linked to a preceding block record and, through that preceding block record, to each earlier block record in turn back to a genesis block record—the only block record which does not contain a link to a preceding block record. Although the hash value is typically simple to compute, there may be one or more validity requirements imposed on the hash value. In addition, the hash value is normally based on a special type of mathematical function that is not reversible and so one cannot readily know which input will give a desired output without trialling numerous inputs.

The integrity of payload data stored in the blockchain is ensured because each block record links to a preceding block record and because in order to tamper with payload data in a block record of the blockchain, a tampering party would have to do further work to store the tampered block and each subsequent block on the blockchain, which is infeasible while the majority of nodes of the blockchain network are each checking the validity of the blockchain and adding their own block records.

Returning again to FIG. 16, the apparatus 200 includes a number of user interfaces including visualising means such as a visual display 230 and a virtual or dedicated user input device such as keyboard 240. The user interfaces displayed on the visual display by the instructions stored in the memory may include some of the reports of the inputs and outputs of the solver shown in FIGS. 2-10.

The communications module 250 is suitable for sending and receiving communications between processor 210 and remote systems. For example, communications module 250 may be used to send and receive communications via a communication network 110 such as the Internet. The communications module may thus send and receive data between nodes of the network.

The port 260 is suitable for receiving, for example, a non-transitory computer readable medium containing instruction to be processed by the processor 210.

The processor 210 is configured to receive data, access the memory 220, and to act upon instructions received either from said memory 220 or a computer-readable storage medium connected to port 260, from communications module 250 or from user input device 240.

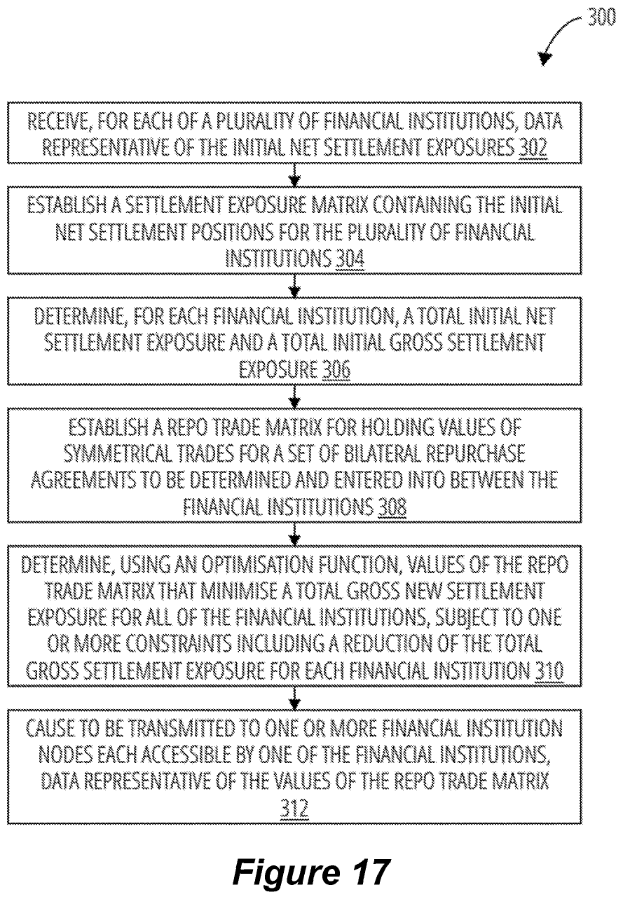

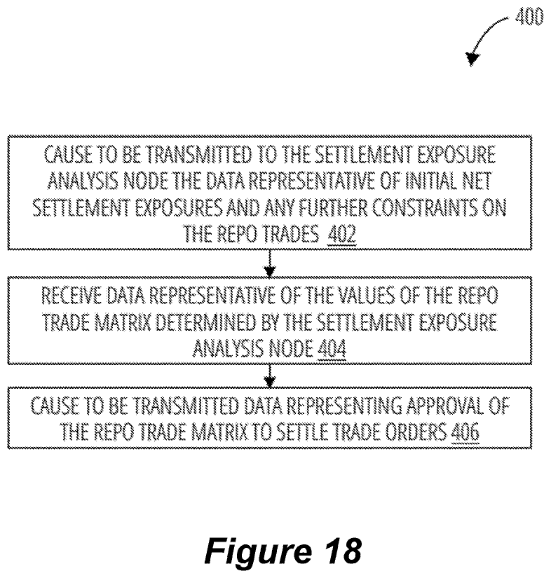

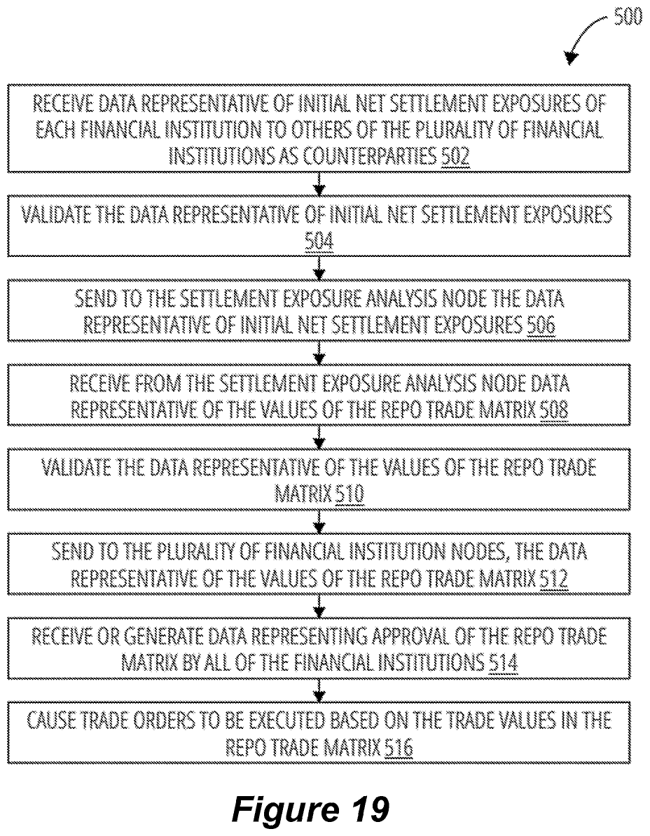

Reference will now be made to FIGS. 17, 18, and 19 which show flowcharts of computer-implemented methods for use in managing the leverage exposure of a plurality of financial institutions in accordance with examples of the present disclosure. Specifically, FIG. 17 shows a flowchart of a computer-implemented method 300 of a settlement exposure analysis node 105 in accordance with examples of the present disclosure. FIG. 18 shows a flowchart of a computer-implemented method 400 of a financial institution node 101i in accordance with examples of the present disclosure. FIG. 19 shows a flowchart of a computer-implemented method 500 of a regulated arranger node 103 in accordance with examples of the present disclosure.

Referring to FIG. 18, in method 400, in step 402 each participating financial institution node 101i, causes to be transmitted to the settlement exposure analysis node 105 the data representative of initial net settlement exposures and any further constraints on the repo trades. In particular, each financial institution node 101i causes, by a financial institution node accessible by a financial institution i, to be transmitted to the settlement exposure analysis node the data representative of initial net settlement exposures E_{i,j} of that financial institution i to others of the plurality of financial institutions as counterparties j=1, . . .n. That is, E_{i,j} is the initial exposure between counterparty i and j (with E_{i,j}=0.) An example of this data may be as shown in the user interface in FIG. 2.

In embodiments, each financial institution node 101i may cause to be transmitted to settlement exposure analysis node 105 data representative of one or more additional constraints to be placed on the determination of the repo trade matrix x_{i,j} by the settlement exposure analysis node 105. Further constraints may be set by the settlement exposure analysis node 105 without input from the financial institution nodes 101i, or on the basis of previous data instructions.

One such constraint may include a maximum absolute total new trade exposure for the values of the trades for a given financial institution i. That is Aᵢ, a set of positive numbers representing the maximum absolute total new trade exposure permitted for financial institution i (i.e. the absolute of the sum of exposures for the new trades for counterparty i).

Another such constraint may include a limit on the settlement exposure between given counterparties i,j before and after the trades. That is Lᵢ, a set of positive numbers representing the limit on exposure in absolute terms between counterparty i and counterparty j before and after the new trades are included.

Another such constraint may include an upper and/or lower limit for the value of a trade between given counterparties i,j. That is T_{i,j}, a pair of numbers containing the lower and upper bounds for the permitted new trade size.

Referring now to FIG. 19, in method 500, the regulated arranger node 103 may act to receive, validate and send data between the participating financial institution nodes 101i, settlement exposure analysis node 105 and Multilateral Trading Facility (MTF) 107. That is, in step 502, the regulated arranger node 103 receives from each of the participating financial institution nodes 101i data representative of initial net settlement exposures of each financial institution to others of the plurality of financial institutions as counterparties. In step 504, the regulated arranger node 103 validates the data representative of initial net settlement exposures. In step 506, the regulated arranger node 103 sends to the settlement exposure analysis node 105 the data representative of initial net settlement exposures.

Referring now to FIG. 17, in step 302, the settlement exposure analysis node 105 receives from regulated arranger node 103, for each of a plurality of financial institutions, data representative of the initial net settlement exposures. That is, for each i of a plurality n of financial institutions i=1 . . . n, data representative of the initial net settlement exposure E_{i,j} of that financial institution i to others of the plurality of financial institutions as counterparties j=1, . . . n, includes the net settlement exposure E_{i,j} indicated as net positive or negative cashflow obligations between the financial institutions at a target settlement date corresponding to a date intended for a set of repurchase agreements to be determined and entered into.

In step 304, the settlement exposure analysis node 105 establishes a settlement exposure matrix containing the initial net settlement positions for the plurality of financial institutions. That is, the settlement exposure matrix contains the initial net settlement positions E_{i,j} from the data received for the plurality of financial institutions and is stored in memory 220 in an appropriate form to allow operation by an optimisation function software module.

In step 306, based on the settlement exposure matrix, the settlement exposure analysis node 105 determines, for each financial institution, a total initial net settlement exposure and a total initial gross settlement exposure. These may be used in the optimisation function.

For each financial institution i of the plurality of financial institutions, a total initial net settlement exposure to the j=1 . . . n counterparties is determined as:

$$∀ i {\sum }_{j = 1}^{n} {E}_{i , j}$$

For each financial institution i of the plurality of financial institutions, a total initial gross settlement exposure to the j=1 . . . n counterparties based on an absolute amount of the settlement exposure is determined as:

$$∀ i {\sum }_{j = 1}^{n} \vert {E}_{i , j} \vert$$

In step 308, the settlement exposure analysis node 105 establishes a repo trade matrix x_{i,j} for holding values of symmetrical trades for a set of bilateral repurchase agreements to be determined and entered into between the financial institutions i,j=1 . . . n.

In step 310, the settlement exposure analysis node 105 determines, using an optimisation function, values of the repo trade matrix that minimise a total gross new settlement exposure for all of the financial institutions, subject to one or more constraints including a reduction of the total gross settlement exposure for each financial institution.

That is, values of the repo trade matrix x_{i,j} that minimise a total gross new settlement exposure for all of the financial institutions i,j=1 . . . n are determined using an optimisation function. The total gross new exposure is calculated by:

$${\sum }_{i = 1}^{n} {\sum }_{j = 1}^{n} \vert {x}_{i , j} + {E}_{i , j} \vert$$

The optimisation can be performed by a suitable optimisation algorithm, such as the minimisation function scipy.optimize.minimize provided by the SciPy python library maintained at https://scipy.org/.

The optimisation is subject to the constraint that for each financial institution i of the plurality of financial institutions, a total new gross settlement exposure to the j=1 . . . n counterparties after the trades is less than the total initial gross settlement exposure to the j=1 . . . n counterparties, such that:

$$∀ i {\sum }_{j = 1}^{n} \vert {x}_{i , j} + {E}_{i , j} \vert \leq {\sum }_{j = 1}^{n} \vert {E}_{i , j} \vert$$

Where further constraints are received from the financial institution nodes 101i as data representative of one or more additional constraints to be placed on the determination of the repo trade matrix x_{i,j} by the settlement exposure analysis node 105, these are applied to the optimisation function. Further constraints may also be set by the settlement exposure analysis node 105 without input from the financial institution nodes 101i (such as using user interface in FIG. 5), or on the basis of previous data instructions.

The further constraints on the optimisation, where applied, may be applied as follows:

Maximum total new trade exposure by counterparty constraint. For each counterparty the absolute sum of the new trades must be less than or equal to a set limit A:

$$∀ i {\sum }_{j = 1}^{n} \vert {x}_{i , j} + {E}_{i , j} \vert \leq {A}_{i}$$

Symmetry constraint. Counterparty j's trade with i must be inverse of i's with j:

∀i,jx_{i,j}+x_{j,i}=0

Counterparty exposure limit constraint. For each counterparty pair the absolute gross exposure must be less than the single limit set for that pair:

∀i,j|x_{i,j}+E_{i,j}|≤L_{i,j}

Trade limit constraints. For each counterparty pair the new trade exposure must be within the bonds set for that pair:

∀i,jx_{i,j}≥T_{i,j}(lower), x_{i,j}≤T_{i,j}(upper)

In this way, in step 310, the settlement exposure analysis node 105 determines, using the above optimisation function, values of the repo trade matrix x_{i,j} that minimise a total gross new settlement exposure for all of the financial institutions, subject to one or more constraints including a reduction of the total gross settlement exposure for each financial institution.

The problem as specified above is non-linear. The objective function is not linear and neither are some of the constraints. It can be solved by a non-linear solver such as provided by scipy.optimize.minimize but there are some drawbacks. First, the performance of the optimisation is uncertain. Further, it is difficult to be confident that the global optimal reduction in gross exposure has been achieved. A solution might be a local optimum instead.

Fortunately, the problem is not inherently non-linear and it can be re-formulated into linear form as follows. Firstly, the non-linear constraints are all in the form |linearexpression|<=value. Constraints of this form can be transformed into two linear constraints to give an equivalent linear problem:

|linearexpression|≤value≡linearexpression≤value,−linearexpression≤value

Secondly, the non-linear objective function, a minimisation, can also be transformed into an equivalent linear problem by introducing new variables and constraints between the original and new variables. The problem

minimise(|linear function(x)|)

(by changing x) is equivalent to

minimise (a) subject to. a≥linearfunction(x), a≥−linearfunction(x)

(by changing both x and a).

Applying this to linearise the current problem, a new variable, a_{i,j}, is introduced and the problem of minimising the gross exposure is reformulated as

$${\sum }_{i = 1}^{n} {\sum }_{j = 1}^{n} {a}_{i , j}$$

where the calculation is subject to the two linear constraints relating x and a:

∀i,ja_{i,j}≥x_{i,j}+E_{i,j},a_{i,j}≥−x_{i,j}−E_{i,j}

The optimisation function may now be selected to be a linear optimisation function. Note a_{i,j} are absolute values but do not need to be constrained to be.

The further constraints on the optimisation, where applied, are also linearised as follows.

Gross exposure reduction by counterparty constraint:

$$∀ i {\sum }_{j = 1}^{n} {a}_{i , j} \leq {\sum }_{j = 1}^{n} \vert {E}_{i , j} \vert$$

Maximum total new trade exposure by counterparty constraint:

$$∀ i {\sum }_{j = 1}^{n} {x}_{i , j} \leq {A}_{i} ∀ i - {\sum }_{j = 1}^{n} {x}_{i , j} \leq {A}_{i}$$

Symmetry constraint:

∀i,jx_{i,j}+x_{j,i}=0

Counterparty exposure limit constraint:

∀i,ja_{i,j}≤L_{i,j}

Trade limit constraints:

∀i,jx_{i,j}≥T_{i,j}(lower), x_{i,j}≤T_{i,j}(upper)

The solution found to the linear minimisation problem using a suitable linear optimisation function such as that also provided by scipy.optimize.minimize will reliably be a global minimum given the constraints.

Once the values of the repo trade matrix x_{i,j} that minimise a total gross new settlement exposure for all of the financial institutions are determined, in step 312, the settlement exposure analysis node 105 causes to be transmitted to one or more financial institution nodes each accessible by one of the financial institutions, data representative of the values of the repo trade matrix x_{i,j}. The values of the repo trade matrix x_{i,j} are usable, on approval by the financial institutions, to settle trade orders between the financial institutions i,j=1 . . . n to reduce a leverage exposure for each of the financial institutions i,j=1 . . . n.

Referring again to FIG. 19, in step 508, the regulated arranger node 103 receives from the settlement exposure analysis node 105 data representative of the values of the repo trade matrix x_{i,j}. In step 510, the regulated arranger node 103 validates the data representative of the values of the repo trade matrix x_{i,j}. In step 512 the regulated arranger node 103 sends to the plurality of financial institution nodes 101i, the data representative of the values of the repo trade matrix x_{i,j}.

Referring again to FIG. 18, in step 404, each financial institution node 101i receives data representative of the values of the repo trade matrix x_{i,j} determined by the settlement exposure analysis node. Assuming the financial institution approves of the proposed trades (which may be done automatically by financial institution node 101i based on pre-programmed acceptance criteria or may be performed manually, for example reviewing the trades on user interfaces shown in FIGS. 8, 9 and 10), in step 406, the approving financial institution node 101i causes to be transmitted data representing approval of the repo trade matrix to settle trade orders between the financial institution i and each of the j=1 . . . n counterparties. This is sent to the regulated arranger node 103.

Referring again to FIG. 19, in step 514, the regulated arranger node 103 receives or generates data representing approval of the repo trade matrix by all of the financial institutions. That is, for one or more financial institutions, the regulated arranger node 103 may itself approve the repo trade matrix, for example, based on predetermined acceptance conditions for the repo trades provided by the financial institution.

Only once approval is received from all participating financial institutions, does the process proceed to issuing trade orders in step 516. If not all of the participating financial institutions issue their approval, then the trades proposed in the repo trade matrix x_{i,j} do not proceed. However, if approval from all participating financial institutions is received, in step 516, the regulated arranger node 103 causes trade orders to be executed based on the trade values in the repo trade matrix x_{i,j}. Causing trade orders to be executed may comprises generating, based on the values of the repo trade matrix x_{i,j}, trade execution instructions for the repurchase agreements between the financial institutions i,j=1 . . . n, and causing the trade execution instructions to be sent to a multilateral trading facility 107 for execution of the repurchase agreements by straight through processing.

As explained above in relation to FIGS. 11, 12 and 16, one or more of the settlement exposure analysis node 105, regulated arranger node 103 and at least one financial institution node 101i may be configured by DLT software to securely store the data representative of initial net settlement exposures E_{i,j}, data representative of the values of the repo trade matrix x_{i,j}, and data representing approval of the repo trade matrix x_{i,j} by all of the financial institutions, in a distributed ledger maintained by at least each of the nodes based on a consensus mechanism. The distributed ledger maintained by the nodes may store instructions implementing smart contracts which when executed, cause a processor of one of the nodes to, based on data representing approval of the repo trade matrix x_{i,j} by all of the participating financial institution nodes, settle trade orders between pairs of the financial institutions i,j based on the trade values in the repo trade matrix x_{i,j} for those counterparties. The settlement exposure analysis node 105, regulated arranger node 103 and at least one financial institution node 101i may be configured, at least in part by the instructions implementing smart contracts, such that data representative of initial net settlement exposures E_{i,j} is periodically issued by the financial institutions; the resulting data representative of the values of the repo trade matrix x_{i,j} is automatically generated by the settlement exposure analysis node 105; and the regulated arranger node 103 automatically causes trade orders to be executed between pairs of the financial institutions i,j based on the data representing approval of the repo trade matrix x_{i,j} by all of the participating financial institution nodes 101i.

In this way, by the collation and validation of the data in a transparent way using a distributed ledger, by using an optimisation function to minimise an objective function, and by using smart contracts to automatically settle the trades, the system 100 of networked computing apparatus can securely and reliably automatically construct and execute a set of bilateral repo market trades to reduce the leverage exposure of the participating financial institutions.

The trades having the values proposed in the repo trade matrix x_{i,j}, are all to use the same price. Further, as can be seen in the worked examples in FIGS. 8, 14 and 15, the net of all trades in the repo trade matrix x_{i,j} is zero such that, for each financial institution i of the plurality of financial institutions, the total new net settlement exposure to the j=1 . . . n counterparties will be equal to the total initial net settlement exposure to the j=1 . . . n counterparties. As a result there is no price negotiation required as no one is exposed to the price at which all the trades are executed, because all trades use the same price and the net of all trades is zero for all participants.

The result of transacting the trades according to the values of the repo trade matrix x_{i,j} is such that the leverage exposure of each financial institution i is reduced by half of the total gross value of the repurchase agreement trades with each of the counterparties j. For example, as can be seen in the results shown for worked example in FIG. 6, the leverage exposure saving (i.e. the difference between the initial leverage exposure and the new leverage exposure) for each financial institution, corresponds to half the volume of repurchase agreement trades transacted by that financial institution according to the optimised repo trade matrix x_{i,j} (this is due to the symmetrical nature of the trades and the repo trade matrix x_{i,j}).

Although as described above, the participants in the system 100 may be a well-rated bank (as these institutions generate the largest flows in the repo market and, between them, create the critical mass necessary for efficient leverage ratio management), the system 100 may be widened to include other participants such as well-rated funds. Each of the participants may specify which of its peer group it is prepared to trade risk-reducing transactions and in what volumes.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. In particular, any dependent claims may be combined with any of the independent claims and any of the other dependent claims.

1. A computer-implemented method for use in managing the leverage exposure of a plurality of financial institutions, comprising:
receiving, by a settlement exposure analysis node, for each i of a plurality n of financial institutions i=1 . . . n, data representative of the initial net settlement exposure E_{i,j} of that financial institution i to others of the plurality of financial institutions as counterparties j=1, . . . n, the net settlement exposure E_{i,j} indicated as net positive or negative cashflow obligations between the financial institutions at a target settlement date corresponding to a date intended for a set of repurchase agreements to be determined and entered into;
establishing, by the settlement exposure analysis node, a settlement exposure matrix containing the initial net settlement positions E_{i,j} for the plurality of financial institutions, and determining, at the settlement exposure analysis node:
for each financial institution i of the plurality of financial institutions, a total initial net settlement exposure to the j=1 . . . n counterparties as:
$$∀ i {\sum }_{j = 1}^{n} {E}_{i , j}$$
for each financial institution i of the plurality of financial institutions, a total initial gross settlement exposure to the j=1 . . . n counterparties based on an absolute amount of the settlement exposure as:
$$∀ i {\sum }_{j = 1}^{n} \vert {E}_{i , j} \vert$$
establishing, by the settlement exposure analysis node, a repo trade matrix x_{i,j} for holding values of symmetrical trades for a set of bilateral repurchase agreements to be determined and entered into between financial institutions i,j=1 . . . n;
determining, by the settlement exposure analysis node using an optimisation function, values of the repo trade matrix x_{i,j} that minimise a total gross new settlement exposure for all of the financial institutions i,j=1 . . . n, the total gross new exposure being calculated by:
$${\sum }_{i = 1}^{n} {\sum }_{j = 1}^{n} \vert {x}_{i , j} + {E}_{i , j} \vert$$
wherein the optimisation is subject to the constraint that for each financial institution i of the plurality of financial institutions, a total new gross settlement exposure to the j=1 . . . n counterparties after the trades is less than the total initial gross settlement exposure to the j=1 . . . n counterparties, such that:
∀iΣⱼ₌₁ⁿ|x_{i,j}+E_{i,j}|≤Σⱼ₌₁ⁿ|E_{i,j}| and;
causing, by the settlement exposure analysis node, to be transmitted to one or more financial institution nodes each accessible by one of the financial institutions, data representative of the values of the repo trade matrix x_{i,j}, the values of the repo trade matrix x_{i,j} being usable, on approval by the financial institutions, to settle trade orders between the financial institutions i,j=1 . . . n to reduce a leverage exposure for each of the financial institutions i,j=1 . . . n.

2. A method as claimed in claim 1, wherein determining, using an optimisation function, values of the repo trade matrix x_{i,j}, is further subject to the constraint that each trade in the trade matrix x_{i,j} reduces the gross settlement exposure for each counterparty i,j to that trade.

3. A method as claimed in claim 1, wherein in determining, using an optimisation function, values of the repo trade matrix x_{i,j}, the trades are all to use the same price.

4. A method as claimed in claim 1, wherein in determining, using an optimisation function, values of the repo trade matrix x_{i,j}, the net of all trades is zero such that, for each financial institution i of the plurality of financial institutions, the total new net settlement exposure to the j=1 . . . n counterparties is equal to the total initial net settlement exposure to the j=1 . . . n counterparties.

5. A method as claimed in claim 1, wherein the result of transacting the trades according to the values of the repo trade matrix x_{i,j} is such that the leverage exposure of each financial institution i is reduced by half of the total gross value of the repurchase agreement trades with each of the counterparties j.

6. A method as claimed in claim 1, wherein determining, using an optimisation function, values of the repo trade matrix x_{i,j}, is subject to one or more additional constraints received at the settlement exposure analysis node, including:
a maximum absolute total exposure for the values of the trades for a given financial institution i; and/or
a limit on the settlement exposure between given counterparties i,j before and after the trades; and/or
an upper and/or lower limit for the value of a trade between given counterparties i,j.

7. A method as claimed in claim 1, wherein one of the financial institutions i participating the bilateral repurchase agreements is a central clearing counterparty (CCP).

8. A method as claimed in claim 1, wherein the calculation of the total gross new exposure to be minimised using an optimisation function is transformed to a linear form:
$${\sum }_{i = 1}^{n} {\sum }_{j = 1}^{n} {a}_{i , j}$$
where the calculation is subject to the two linear constraints:
∀i,ja_{i,j}≥x_{i,j}+E_{i,j},a_{i,j}≥−x_{i,j}−E_{i,j}
and wherein the optimisation function is a linear optimisation function.

9. A method as claimed in claim 1, further comprising:
causing, by a financial institution node accessible by a financial institution i, to be transmitted to the settlement exposure analysis node the data representative of initial net settlement exposures E_{i,j} of that financial institution i to others of the plurality of financial institutions as counterparties j=1, . . . n;
receiving, by the financial institution node, data representative of the values of the repo trade matrix x_{i,j} determined by the settlement exposure analysis node.

10. A method as claimed in claim 9, further comprising:
causing, by the financial institution node, to be transmitted to settlement exposure analysis node data representative of one or more additional constraints to be placed on the determination of the repo trade matrix x_{i,j} by the settlement exposure analysis node.

11. A method as claimed in claim 9, further comprising:
causing, by the financial institution node, to be transmitted data representing approval of the repo trade matrix x_{i,j} to settle trade orders between the financial institution i and each of the j=1 . . . n counterparties.

12. A method as claimed in claim 1, comprising:
receiving, by a regulated arranger node, from a plurality of financial institution nodes, data representative of initial net settlement exposures E_{i,j} of each financial institution i=1, . . . n to others of the plurality of financial institutions as counterparties j=1, . . . n;
validating, by the regulated arranger node, the data representative of initial net settlement exposures E_{i,j};
sending, by the regulated arranger node, to the settlement exposure analysis node, the data representative of initial net settlement exposures E_{i,j};
receiving, by the regulated arranger node, from the settlement exposure analysis node, data representative of the values of the repo trade matrix x_{i,j} determined by the settlement exposure analysis node;
validating, by the regulated arranger node, the data representative of the values of the repo trade matrix x_{i,j};
sending, by the regulated arranger node, to the plurality of financial institution nodes, the data representative of the values of the repo trade matrix x_{i,j};
by the regulated arranger node, receiving or generating based on predetermined acceptance conditions determined by one or more of the financial institutions, data representing approval of the repo trade matrix x_{i,j} by all of the financial institutions; and
causing, by the regulated arranger node, trade orders to be executed between pairs of the financial institutions i,j based on the trade values in the repo trade matrix x_{i,j} for those counterparties.

13. A method as claimed in claim 12, wherein causing, by the regulated arranger node, trade orders to be executed comprises:
generating, based on the values of the repo trade matrix x_{i,j}, trade execution instructions for the repurchase agreements between the financial institutions i,j=1 . . . n; and
causing the trade execution instructions to be sent to a multilateral trading facility node for execution of the repurchase agreements by straight through processing.

14. A method as claimed in claim 1, wherein one or more of the settlement exposure analysis node, regulated arranger node and at least one financial institution node securely store the data representative of initial net settlement exposures E_{i,j}, data representative of the values of the repo trade matrix x_{i,j}, and data representing approval of the repo trade matrix x_{i,j} by all of the financial institutions, in a distributed ledger maintained by at least each of the nodes based on a consensus mechanism.

15. A method as claimed in claim 14, wherein the distributed ledger maintained by the nodes stores instructions implementing smart contracts which when executed, cause a processor of one of the nodes to, based on data representing approval of the repo trade matrix x_{i,j} by all of the participating financial institution nodes, settle trade orders between pairs of the financial institutions i,j based on the trade values in the repo trade matrix x_{i,j} for those counterparties.

16. A method as claimed in claim 15, wherein the settlement exposure analysis node, regulated arranger node and at least one financial institution node are configured, at least in part by the instructions implementing smart contracts, such that:
data representative of initial net settlement exposures E_{i,j} is periodically issued by the financial institutions;
the resulting data representative of the values of the repo trade matrix x_{i,j} is automatically generated by the settlement exposure analysis node; and
the regulated arranger node automatically causes trade orders to be executed between pairs of the financial institutions i,j based on the data representing approval of the repo trade matrix x_{i,j} by all of the participating financial institution nodes.

17. A computing apparatus for providing a settlement exposure analysis node for use in managing the leverage exposure of a plurality of financial institutions, comprising:
one or more processors; and
memory comprising instructions which when executed by one or more of the processors, causes the processors to:
receive, for each i of a plurality n of financial institutions i=1 . . . n, data representative of the initial net settlement exposure E_{i,j} of that financial institution i to others of the plurality of financial institutions as counterparties j=1, . . . n, the net settlement exposure E_{i,j} indicated as net positive or negative cashflow obligations between the financial institutions at a target settlement date corresponding to a date intended for a set of repurchase agreements to be determined and entered into;
establish a settlement exposure matrix containing the initial net settlement positions E_{i,j} for the plurality of financial institutions, and determine:
for each financial institution i of the plurality of financial institutions, a total initial net settlement exposure to the j=1 . . . n counterparties as:
$$∀ i {\sum }_{j = 1}^{n} {E}_{i , j}$$
for each financial institution i of the plurality of financial institutions, a total initial gross settlement exposure to the j=1 . . . n counterparties based on an absolute amount of the settlement exposure as:
$$∀ i {\sum }_{j = 1}^{n} \vert {E}_{i , j} \vert$$
establish a repo trade matrix x_{i,j} for holding values of symmetrical trades for a set of bilateral repurchase agreements to be determined and entered into between financial institutions i,j=1 . . . n;
determine, using an optimisation function, values of the repo trade matrix x_{i,j} that minimise a total gross new settlement exposure for all of the financial institutions i,j=1 . . . n, the total gross new exposure being calculated by:
$${\sum }_{i = 1}^{n} {\sum }_{j = 1}^{n} \vert {x}_{i , j} + {E}_{i , j} \vert$$
wherein the optimisation is subject to the constraint that for each financial institution i of the plurality of financial institutions, a total new gross settlement exposure to the j=1 . . . n counterparties after the trades is less than the total initial gross settlement exposure to the j=1 . . . n counterparties, such that:
∀iΣⱼ₌₁ⁿ|x_{i,j}+E_{i,j}|≤Σⱼ₌₁ⁿ|E_{i,j}| and;
cause to be transmitted to one or more financial institution nodes each accessible by one of the financial institutions, data representative of the values of the repo trade matrix x_{i,j}, the values of the repo trade matrix x_{i,j} being usable, on approval by the financial institutions, to settle trade orders between the financial institutions i,j=1 . . . n to reduce a leverage exposure for each of the financial institutions i,j=1 . . . n.

18. The computing apparatus of claim 17 for providing a financial institution node, accessible by a financial institution i, for use in managing the leverage exposure of a plurality of financial institutions, comprising:
one or more processors; and
memory comprising instructions which when executed by one or more of the processors, causes the processors to:
cause to be transmitted to a settlement exposure analysis node data representative of initial net settlement exposures E_{i,j} of that financial institution i to others of the plurality of financial institutions as counterparties j=1, . . . n, the net settlement exposure E_{i,j} indicated as net positive or negative cashflow obligations between the financial institutions at a target settlement date corresponding to a date intended for a set of repurchase agreements to be determined and entered into;
receive data representative of the values of a repo trade matrix x_{i,j} determined by the settlement exposure analysis node, the repo trade matrix x_{i,j} holding values of symmetrical trades for a set of bilateral repurchase agreements to be entered into between the financial institution i and the plurality of other financial institutions as counterparties j=1, . . . n to reduce a leverage exposure for each of the financial institutions i,j=1 . . . n; and
causing to be transmitted data representing approval of the repo trade matrix x_{i,j} to settle trade orders between the financial institution i and each of the j=1 . . . n counterparties.

19. The computing apparatus of claim 18 for providing a regulated arranger node for use in managing the leverage exposure of a plurality of financial institutions, comprising:
one or more processors; and
memory comprising instructions which when executed by one or more of the processors, causes the processors to:
receive from a plurality of financial institution nodes, data representative of initial net settlement exposures E_{i,j} of each financial institution i=1, . . . n to others of the plurality of financial institutions as counterparties j=1, . . . n;
validate the data representative of initial net settlement exposures E_{i,j};
send to the settlement exposure analysis node, the data representative of initial net settlement exposures E_{i,j};
receive from the settlement exposure analysis node, data representative of the values of the repo trade matrix x_{i,j} determined by the settlement exposure analysis node;
validate the data representative of the values of the repo trade matrix x_{i,j};
send to the plurality of financial institution nodes, the data representative of the values of the repo trade matrix x_{i,j};
receive or generate based on predetermined acceptance conditions determined by one or more of the financial institutions, data representing approval of the repo trade matrix x_{i,j} by all of the financial institutions; and
cause trade orders to be executed between pairs of the financial institutions i,j based on the trade values in the repo trade matrix x_{i,j} for those counterparties.

20. The computing apparatus of claim 19, wherein the settlement exposure analysis node, regulated arranger node and at least one financial institution node are configured to, in use, transfer data representative of initial net settlement exposures of the participating financial institutions from the financial institution nodes to the settlement exposure analysis node, transfer data representative of the values of a repo trade matrix x_{i,j} generated by the settlement exposure analysis node to the financial institution nodes, and, based on data representing approval of the repo trade matrix x_{i,j} by all of the participating financial institution nodes, settle trade orders between pairs of the financial institutions i,j based on the trade values in the repo trade matrix x_{i,j} for those counterparties.

21.-24. (canceled)
